(19) United States
(12) Patent Application Publication
(10) Pub. No.: US 2025/0272579 A1
(43) Pub. Date: Aug. 28, 2025

(54) Thresholded Extremal Optimization (TEO)

(71) Applicant: Emory University, Atlanta, GA (US)

(72) Inventor: Stefan Boettcher, Atlanta, GA (US)

(21) Appl. No.: 19/067,219

(22) Filed: Feb. 28, 2025

Related U.S. Application Data
(60) Provisional application No. 63/558,691, filed on Feb. 28, 2024.

(51) Int. Cl. G06N 5/01

(52) U.S. Cl. CPC G06N 5/01

(57) ABSTRACT

In some embodiments, the present disclosure relates to a method. The method includes accessing an instance matrix having a plurality of instance values and a configuration vector having a configuration values. Iterations are performed on a computing apparatus to determine an optimized configuration vector. The iterations respectively include simultaneously determining a plurality of reduction values by multiplying the configuration values by instance values within a row of the instance matrix. A plurality of fitness values are respectively determined using the plurality of reduction values and configuration value associated with a row of the instance matrix. A current cost is determined by summing the plurality of fitness values. Unstable fitness values are simultaneously identified based upon a comparison of the plurality of fitness values with a threshold. At least one of the configuration values associated with the unstable fitness values are simultaneously updated based upon a probabilistic selection.

### CROSS-REFERENCE TO RELATED APPLICATIONS

This application claims the benefit of U.S. Provisional Application No. 63/558,691 filed Feb. 28, 2024. The entirety of this application is hereby incorporated by reference for all purposes.

### BACKGROUND

Combinatorial optimization problems are problems that find an optimal solution from a finite set of feasible solutions. In today's world, combinatorial optimization problems are encountered in many different fields and industries, from finance and economics to machine learning. For example, a supply chain company may utilize a combinatorial optimization problem to determine a most cost-effective way to source, transport, and distribute goods, while an engineer may utilize a combinatorial optimization problem to find optimal parameters for a product's design to meet specific performance criteria while minimizing costs. However, currently available solutions to solve combinatorial optimization problems can face long run times when applied to commercial sized problems (e.g., problems having thousands or millions of variables).

### SUMMARY

Thus, there is a need for methods and apparatuses that can efficiently solve combinatorial optimization problems.

The disclosure relates to methods and apparatuses that are configured to efficiently solve combinatorial optimization problems. In some examples, the disclosed methods and apparatuses simultaneously assess the plurality of fitness values and therefore can enable efficient operation.

Additional advantages of the disclosure will be set forth in part in the description which follows, and in part will be obvious from the description, or may be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

The accompanying drawings, which are incorporated in and constitute a part of the specification, illustrate various example operations, apparatus, methods, and other example embodiments of various aspects discussed herein. It will be appreciated that the illustrated element boundaries (e.g., boxes, groups of boxes, or other shapes) in the figures represent one example of the boundaries. One of ordinary skill in the art will appreciate that, in some examples, one element can be designed as multiple elements or that multiple elements can be designed as one element. In some examples, an element shown as an internal component of another element may be implemented as an external component and vice versa. Furthermore, elements may not be drawn to scale.

FIG. 1 illustrates some embodiments of a flow diagram of a method of determining an optimized configuration vector for a combinatorial optimization problem.

FIG. 2 illustrates some additional embodiments of a flow diagram of a method of determining an optimized configuration vector for a combinatorial optimization problem.

FIGS. 3A-3H illustrate exemplary operations corresponding to a first iteration of a method of determining an optimized configuration vector for a combinatorial optimization problem. FIG. 3A illustrates an exemplary operation of the first iteration of act 202 of FIG. 2; FIG. 3B illustrates an exemplary operation of the first iteration of act 204 of FIG. 2; FIG. 3C illustrates an exemplary operation of the first iteration of act 208 of FIG. 2; FIG. 3D illustrates an exemplary operation of the first iteration of act 210 of FIG. 2; FIG. 3E illustrates an exemplary operation of the first iteration of act 212 of FIG. 2; FIG. 3F illustrates an exemplary operation of the first iteration of acts 214 and 219 of FIG. 2; FIG. 3G illustrates an exemplary operation of the first iteration of act 220 of FIG. 2; and FIG. 3H illustrates exemplary operations of the first iteration of act 222 of FIG. 2.

FIGS. 4A-4G illustrate exemplary operations corresponding to a second iteration of a method of determining an optimized configuration vector for a combinatorial optimization problem. FIG. 4A illustrates an exemplary operation of the second iteration of act 208 of FIG. 2; FIG. 4B illustrates an exemplary operation of the second iteration of act 210 of FIG. 2; FIG. 4C illustrates an exemplary operation of the second iteration of act 212 of FIG. 2; FIG. 4D illustrates an exemplary operation of the second iteration of acts 214 and 219 of FIG. 2; FIG. 4E illustrates an exemplary operation of the second iteration of act 220 of FIG. 2; FIG. 4F illustrates an exemplary operation of the second iteration of act 222, and in particular act 232, of FIG. 2; and FIG. 4G illustrates exemplary operations of the second iteration of acts 222, and in particular acts 224-228, of FIG. 2.

FIG. 5 illustrate a block diagram of some embodiments of an apparatus configured to determine an optimized configuration vector for a combinatorial optimization problem.

FIG. 6 illustrate a block diagram of some additional embodiments of an apparatus configured to determine an optimized configuration vector for a combinatorial optimization problem.

FIG. 7 illustrates some additional embodiments of a flow diagram of a method of determining an optimized configuration vector for a combinatorial optimization problem.

### DETAILED DESCRIPTION

The description herein is made with reference to the drawings, wherein like reference numerals are generally utilized to refer to like elements throughout, and wherein the various structures are not necessarily drawn to scale. In the following description, for purposes of explanation, numerous specific details are set forth in order to facilitate understanding. It may be evident, however, to one of ordinary skill in the art, that one or more aspects described herein may be practiced with a lesser degree of these specific details. In other instances, known structures and devices are shown in block diagram form to facilitate understanding.

Combinatorial optimization problems may be classified in different classes according to computation complexity theory based on how much time and/or space is used to solve a problem and verify a solution. Solving NP-hard combinatorial optimization problems (e.g., traveling salesperson problem, scheduling, packing, satisfiability, or the like), where computational complexity grows faster than any power in the size of the problem, is at the heart of many problems in modern technology, operations research, artificial intelligence (AI), quantum computing, finance, etc. To find solutions to such problems of any practical size is computational prohibitive, and many polynomial-time “heuristic” algorithms have been devised to find good approximations in a relatively fast time.

One such problem is Quadratic Unconstrained Binary Optimization (QUBO). QUBO models can be used to encode a wide range of combinatorial optimization problems (e.g., QUBO problems). To improve performance of QUBO problems, customizable hardware may allow for parallelization to dramatically accelerate search heuristics of QUBO problems. Furthermore, quantum annealing computers (e.g., having a network structure comprising qubits) are being developed that are able to very quickly find good solutions to QUBO problems. However, current search heuristics of QUBO problem still face long run times when applied to commercial sized problems (e.g., problems having thousands or millions of variables).

The present disclosure relates to a method and/or apparatus configured to efficiently solve a combinatorial optimization problem (e.g., a QUBO problem). The method accesses an instance matrix comprising a plurality instance values disposed within rows and columns and a configuration vector comprising a plurality of configuration values. Using the instance matrix and the configuration vector, the method performs one or more iterations on a computing apparatus to determine an optimized configuration vector. The one or more iterations respectively comprise simultaneously determining a plurality of reduction values by multiplying the configuration values by instance values within a row of the instance matrix. A plurality of fitness values are determined by summing the plurality of reduction values associated with the rows of the instance matrix and multiplying each sum by the respective configuration value of that row. A current cost is determined by summing the fitness values associated with the plurality of rows. The plurality of fitness values are simultaneously assessed and configuration values are negated if the configuration values are associated with both a fitness value less than a threshold and a random number less than a preset probability. By simultaneously assessing the plurality of fitness values, the disclosed method may operate efficiently. Furthermore, by negating configuration values using a preset probability, deterministic loops can be avoided. Therefore, the disclosed algorithm is able to efficiently find solutions to combinatorial optimization problems.

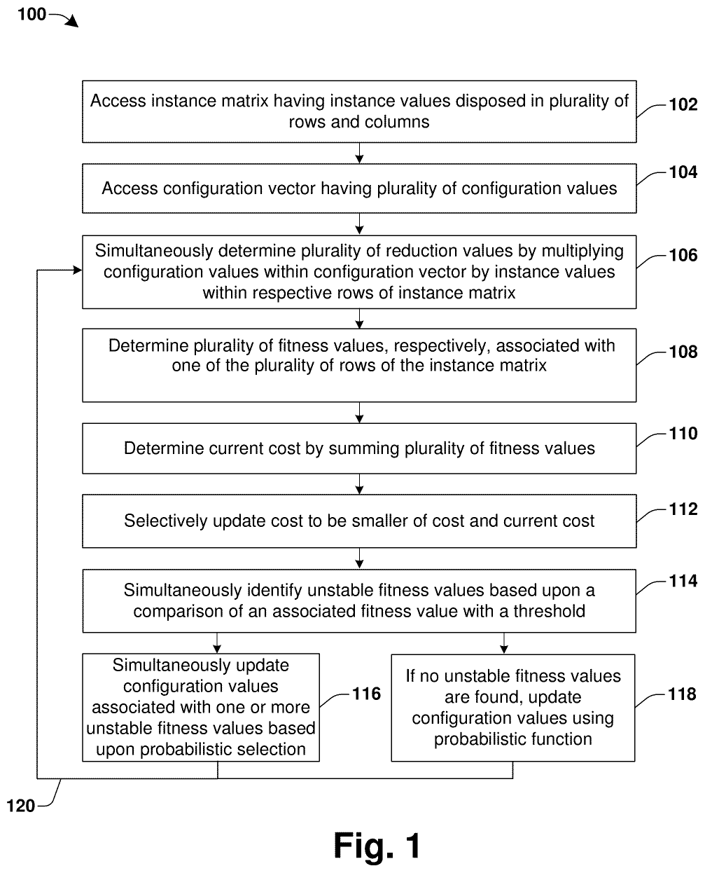

FIG. 1 illustrates some embodiments of a flow diagram of a method 100 of determining an optimized configuration vector for a combinatorial optimization problem.

While the disclosed methods (e.g., methods 100, 200, and 700) are illustrated and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

At act 102, an instance matrix is accessed. The instance matrix comprises a plurality of instance values disposed in rows and columns. The plurality of instance values are associated with an optimization condition to be assessed. In some embodiments, the instance matrix may comprise an N×N matrix. In some embodiments, the instance matrix may be an N×N symmetric matrix.

At act 104, a configuration vector is accessed. The configuration vector comprises a plurality of configuration values. In some embodiments, the plurality of configuration values may comprise Boolean variables or variables with positive or negative values (e.g., values of ‘−1’ or ‘1’). The configuration vector may comprise an N×1 matrix.

At act 106, a plurality of reduction values are simultaneously determined by multiplying the configuration values within the configuration vector by the instance values within respective rows of the instance matrix. For example, a first reduction value may be determined by multiplying a first configuration value within the configuration vector by a first instance value within a row of the instance matrix, a second reduction value may be determined by multiplying a second configuration value within the configuration vector by a second instance value within the row of the instance matrix, etc.

At act 108, a plurality of fitness values, respectively associated with one of the plurality of rows of the instance matrix, are determined. Respective ones of the plurality of fitness values are determined by summing reduction values associated with a row of instance matrix and multiplying the sum with the respective configuration value. The plurality of fitness values are values that denote how little or how much cost each variable contributes to a total cost (e.g., a larger cost corresponds to a lower fitness). In some embodiments, the plurality of fitness values (e.g., all of the plurality of fitness values) may be determined simultaneously (e.g., in parallel), so as to increase a speed and efficiency of the disclosed method 100.

At act 110, a current cost is determined by summing the plurality of fitness values (e.g., all of the plurality of fitness values) associated with the plurality of rows of the instance matrix.

At act 112, a cost is selectively updated to be the smaller of the cost and the current cost.

At act 114, unstable fitness values (e.g., fitness values having a negative value) are simultaneously identified based upon a comparison of a fitness value with a threshold.

At act 116, configuration values (e.g., all of the configuration values) associated with one or more of the unstable fitness values are simultaneously updated (e.g., updated in parallel) based upon a probabilistic selection. Because probabilistic selection is used to update configuration values associated with unstable fitness values, a first number of unstable fitness values will be identified, while a smaller second number of configuration values will be randomly updated. In some embodiments, the probabilistic selection may result in approximately 80% of the configuration values associated with unstable fitness values being randomly negated (while 20% of the configuration values associated with unstable fitness values are not negated).

Although method 100 illustrates acts 110-112 as being performed prior to act 116, it will be appreciated that in alternative embodiments, acts 110-112 may be performed after act 116 (e.g., after configuration values associated with the one or more unstable fitness values have been simultaneously updated).

At act 118, if no unstable fitness values are found, one or more of the plurality of configuration values are updated using a probabilistic function. In some embodiments, one or more of the plurality of configuration values may be updated by increasing a value of the threshold and then comparing the plurality of fitness values to the increased threshold. In other embodiments, one or more of the plurality of configuration values may be updated by selectively updating a random selection of configuration values.

As shown by line 120, the method 100 may be repeated over a plurality of iterations performed on a computing apparatus. During each of the plurality of iterations a new current cost is calculated from an updated configuration vector (e.g., a configuration vector updated at act 116 or act 118). Over the plurality of iterations, the goal of the method 100 is to find a configuration vector (e.g., an arrangement of N Boolean variables) that minimizes the cost.

By simultaneously assessing and updating the configuration values within the configuration vector, the disclosed method 100 is able to efficiently determine an optimized cost for commercial-sized problems (e.g., problems having N equal to approximately 10⁴ to 10⁶, or other similar values). Furthermore, updating the configuration values based upon probabilistic selection eliminates the danger of the method 100 getting trapped in deterministic loops. Therefore, the disclosed method 100 is able to provide for a fast and accurate determination of an optimized configuration vector for a combinatorial optimization problem.

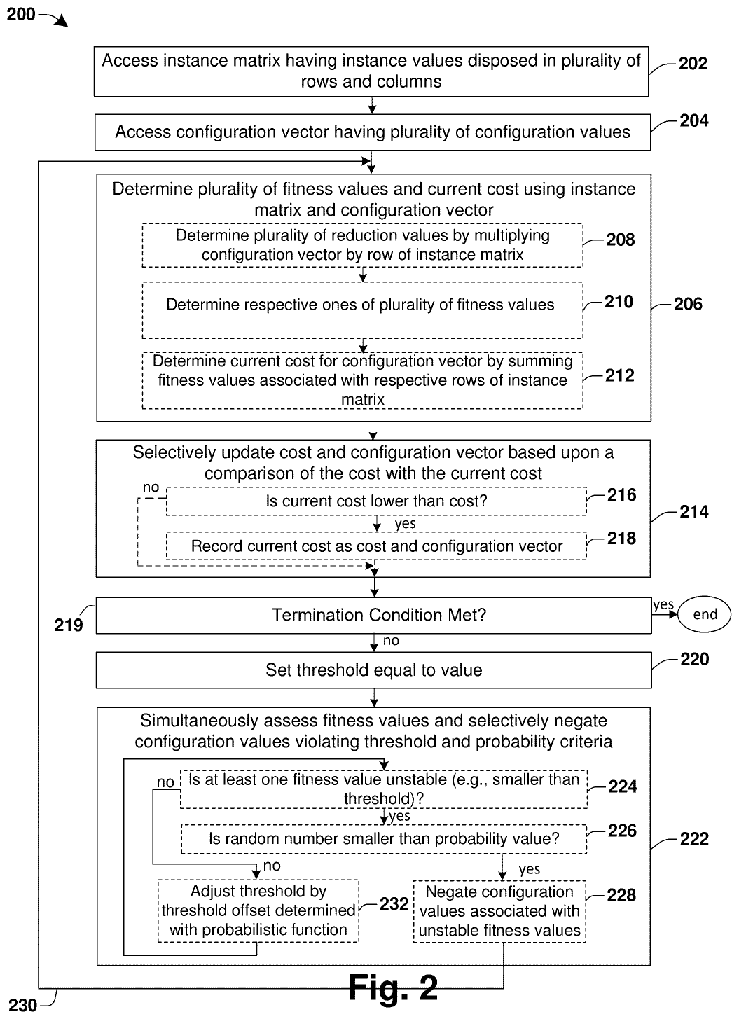

FIG. 2 illustrates some additional embodiments of a flow diagram of a method 200 of determining an optimized configuration vector for a combinatorial optimization problem.

At act 202, an instance matrix is accessed. The instance matrix comprises a plurality of instance values disposed in N rows and N columns. The plurality of instance values are associated with an optimization condition to be assessed. In some embodiments, the optimization condition may be associated with logistics, packing, workflow organization, financial asset management, or the like. For example, the plurality of instance values may be associated with management of a stock portfolio or generation of an academic schedule. In some embodiments, the instance matrix is associated with problems that can easily map (e.g., MAX-SAT, MAX-CUT, MAX-MIN, etc.) into a Quadratic Unconstrained Binary Optimization (QUBO) problem. In some embodiments, the instance matrix may be accessed from electronic memory.

At act 204, a configuration vector is accessed. The configuration vector comprises plurality of configuration values disposed in an N×1 matrix (e.g., a vector). In some embodiments, the configuration vector may be accessed from electronic memory.

At act 206, a plurality of fitness values and a current cost are determined using the instance matrix and the configuration vector. The plurality of fitness values for each of the rows of the instance matrix are respectively equal to Σᵢ₌₁^{N}xᵢQᵢⱼ, wherein xᵢ is the i^{th} value of the configuration vector and Qᵢⱼ is the instance matrix. The current cost is equal to Σᵢ₌₁^{N}Σⱼ₌₁^{N}xᵢQᵢⱼxⱼ, wherein xᵢ is the i^{th} value of the configuration vector, Qᵢⱼ is the instance matrix, and xⱼ is the j^{th} value of the configuration vector. In some embodiments, the current cost may be determined according to acts 208-212.

At act 208, a plurality of reduction values are simultaneously determined by multiplying the configuration values within the configuration vector by the instance values within respective rows of the instance matrix. For example, a first plurality of reduction values may be determined by multiplying the configuration vector by instance values within a first row of the instance matrix (e.g., a first reduction value is equal to a first configuration value of the configuration vector multiplied by a first instance value from the first row of the instance matrix, a second reduction value is equal to a second configuration value of the configuration vector multiplied by a second instance value from the first row of the instance matrix, etc.), a second plurality of reduction values may be determined by multiplying the configuration vector by instance values within a second row of the instance matrix, etc.

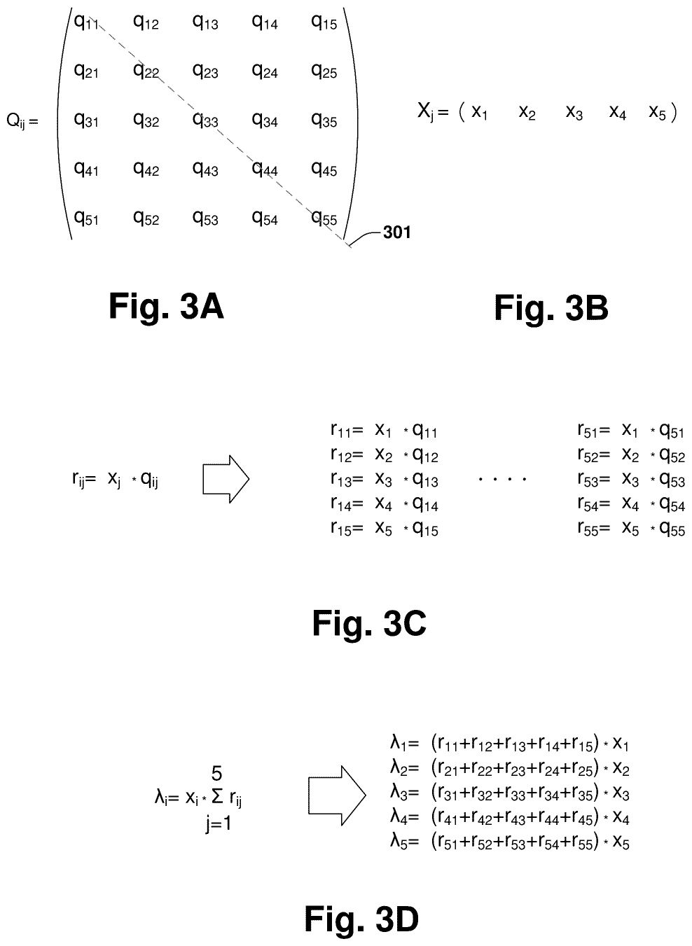

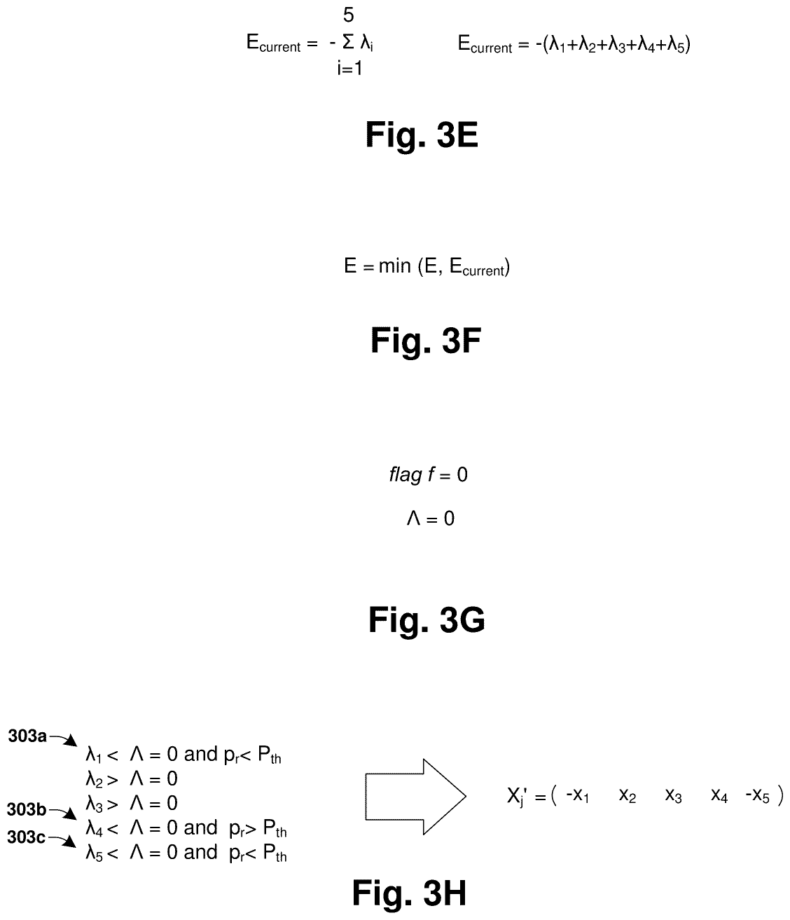

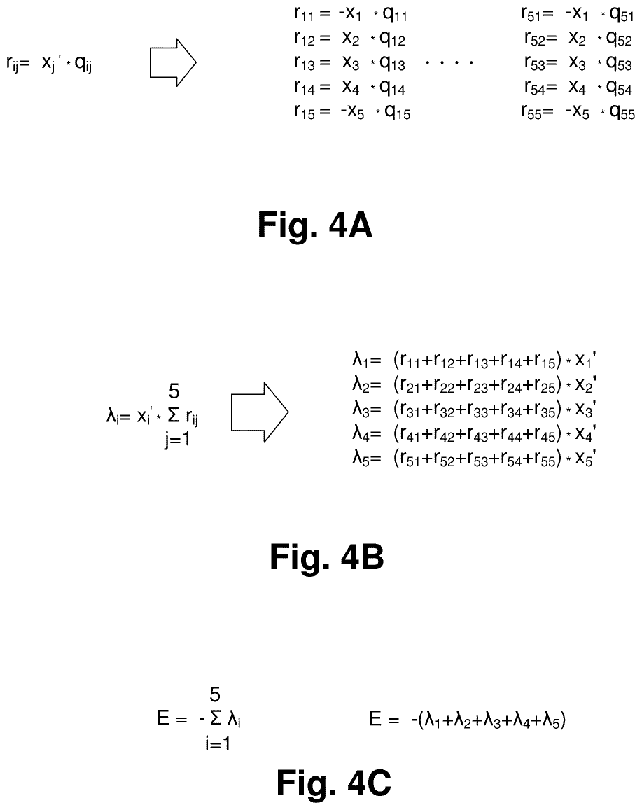

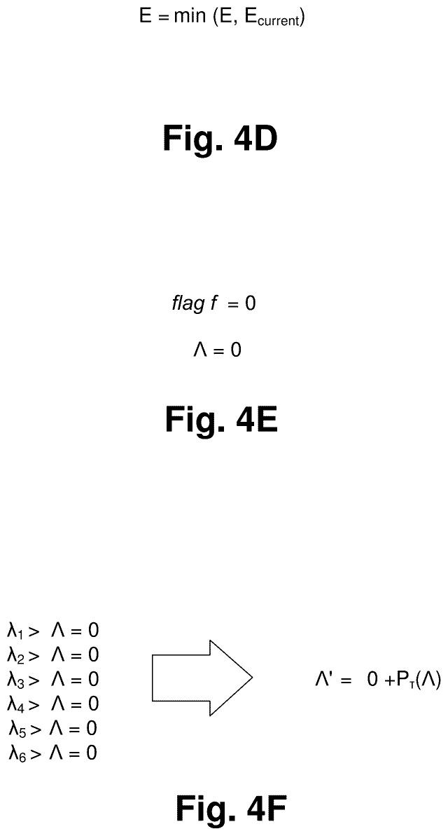

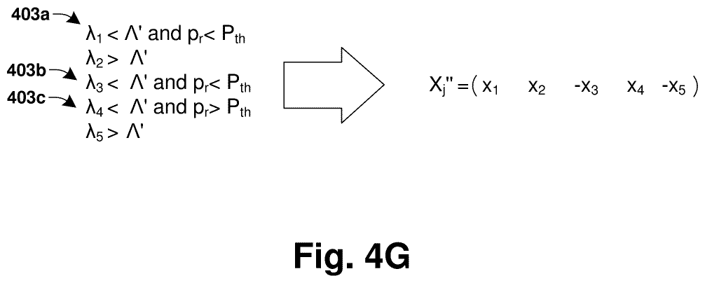

At act 210, a plurality of fitness values, respectively associated with one of the plurality of rows of the instance matrix, are determined. Respective ones of the plurality of fitness values are determined by summing reduction values associated with the row of instance matrix and multiplying each sum with the respective configuration value of that row. For example, xᵢ is the respective configuration value for λᵢ for each i, as shown in FIGS. 3D and 4B. For example, the first fitness value may be determined by summing the first plurality of reduction values associated with the first row of the instance matrix and multiplying that sum by the configuration value for the first row; the second fitness value may be determined by summing the second plurality of reduction values associated with the second row of the instance matrix and multiplying that sum by the configuration value for the second row; etc.

At act 212, the current cost (associated with the configuration vector) is determined by summing the plurality of fitness values associated with the plurality of rows of the instance matrix determined at act 210.

At act 214, a cost and configuration vector are selectively updated based upon a comparison of the cost with the current cost. In some embodiments, the cost and configuration vector are selectively updated according to acts 216-218.

At act 216, the current cost is compared to the cost. If the current cost is lower than the cost, the cost is replaced with the current cost (i.e., the current cost becomes the cost) and the configuration vector associated with the current cost is recorded at act 218. If the current cost is larger than the cost, the cost remains the same.

At act 219, a termination condition is evaluated. For example, the termination condition may correspond to a predetermined number of iterations, a preset target value of the current cost, among others, or any combination thereof. In some examples, a counter may be incremented at act 219 and if that value equals the predetermined number of iterations, the termination condition is satisfied. In other examples, the current cost may be compared to a preset bound of values, and if that current cost is below that preset bound of values, the termination condition is satisfied. If the termination condition is satisfied (yes at act 219), the method 200 ends and the latest value of the cost recorded at act 218 and its respective configuration vector (from act 218) is outputted. For example, output of the value of the cost and its respective configuration vector from act 218 may include but is not limited to storing, displaying, further processing by the system. If the termination condition is not met (no at act 219), the method continues to act 220 (e.g., continues to assess fitness values).

At act 220, a value of a threshold for the fitness value is set. In some embodiments, the value of the threshold may be set equal to zero. In other embodiments, a value of the threshold may be set equal to a value that is different than zero. In some examples, a value for flag f (i.e., a number of unstable fitness values) may also be set. In some examples, the value of flag f may also be set equal to zero.

At act 222, the plurality of fitness values are simultaneously assessed and corresponding configuration values are selectively negated based upon a comparison with the threshold and a probabilistic selection. In some embodiments, the plurality of fitness values may be simultaneously assessed according to acts 224-230.

At act 224, the plurality of fitness values are compared to the threshold to identify unstable fitness values (e.g., fitness values having a negative value).

If one or more of the plurality of fitness values are found to be unstable, then for each unstable fitness value a random number generated by the probabilistic selection is compared to a probability value (e.g., a predetermined probability value) at act 226. If the random number is below the probability value, then a configuration value associated with the unstable fitness value is negated at act 228. If the random number exceeds the probability value, as shown e.g. in 303b of FIG. 3H or 403c in FIG. 4G, then a configuration value associated with the unstable fitness value is not negated (e.g., remains the same). In some embodiments, the predetermined probability value may be between 0 and 1, inclusive. By utilizing a probability value to selectively negate an associated configuration value, the method is able to avoid entering into a deterministic loop. After one or more of the configuration values has been negated, an iteration is complete and the method returns (along line 230) to act 206 to perform a subsequent iteration.

If all of the plurality of fitness values are larger than the threshold (e.g., there are no unstable fitness values), then the threshold is updated at act 232. In some embodiments, the threshold may be updated from a value of zero to a value that is greater than zero. In some embodiments, the threshold is updated based upon a preset probability function. In some embodiments, the probability function may comprise a probability density P_{τ}(ΔΛ). The probability density is a function of an index τ and is configured to randomly select a threshold adjustment (ΔΛ) that is used to increase the original threshold, as illustrated in FIG. 4F (e.g., Λ=Λ+ΔΛ, where Λ is the original threshold and ΔΛ is a threshold adjustment having a value greater than zero). The method 200 then returns to act 224 to compare the plurality of fitness values to the updated threshold. If one or more of the plurality of fitness values are smaller than the updated threshold, then the method proceeds to act 226. If all of the plurality of fitness values are still larger than the updated threshold, then the threshold is updated again (at act 228) and the method returns to act 222 to compare the plurality of fitness values to the updated threshold.

In some embodiments, the probability density P_{τ}(ΔΛ) may determine the threshold adjustment (ΔΛ) by ordering all of the fitness values and then selection of a random rank (e.g., rank k between 1 and n). The threshold adjustment (ΔΛ) is selected to have a value that will cause fitness values that are less than the random rank to become unstable. For example, the threshold adjustment (ΔΛ) may be selected to have a value that will cause 10 out of 100 fitness values to become unstable fitness values. Upon return to act 224, 10 of 100 fitness values will be identified as unstable and then a subset of the unstable fitness values will be negated according to the predetermined probability value (at act 226).

The method 200 may be performed over many iterations to achieve an optimized cost that provides an accurate solution to the optimization task. For example, it has been appreciated that the method may be performed over a number of iterations proportional to N² to achieve an optimized cost that provides an accurate solution to the optimization task.

It will be appreciated that the disclosed methods and/or block diagrams may be implemented as computer-executable instructions, in some embodiments. Thus, in one example, a computer-readable storage device (e.g., a non-transitory computer-readable medium) may store computer executable instructions that if executed by a machine (e.g., computer, processor) cause the machine to perform the disclosed methods and/or block diagrams. While executable instructions associated with the disclosed methods and/or block diagrams are described as being stored on a computer-readable storage device, it is to be appreciated that executable instructions associated with other example disclosed methods and/or block diagrams described or claimed herein may also be stored on a computer-readable storage device.

It will also be appreciated that the disclosed method and/or block diagrams are not able to be carried out by a human as a mental process. This is at least because a human would be unable to carry out the simultaneous operations (e.g., simultaneously determining reduction values, simultaneously determining fitness values, and/or to simultaneously assessing fitness values) that enable the disclosed method and/or apparatus to efficiently determine an optimized configuration vector for a combinatorial optimization problem that is on a commercial scale (e.g., that has an instance matrix and/or a configuration vector with thousand or millions of values).

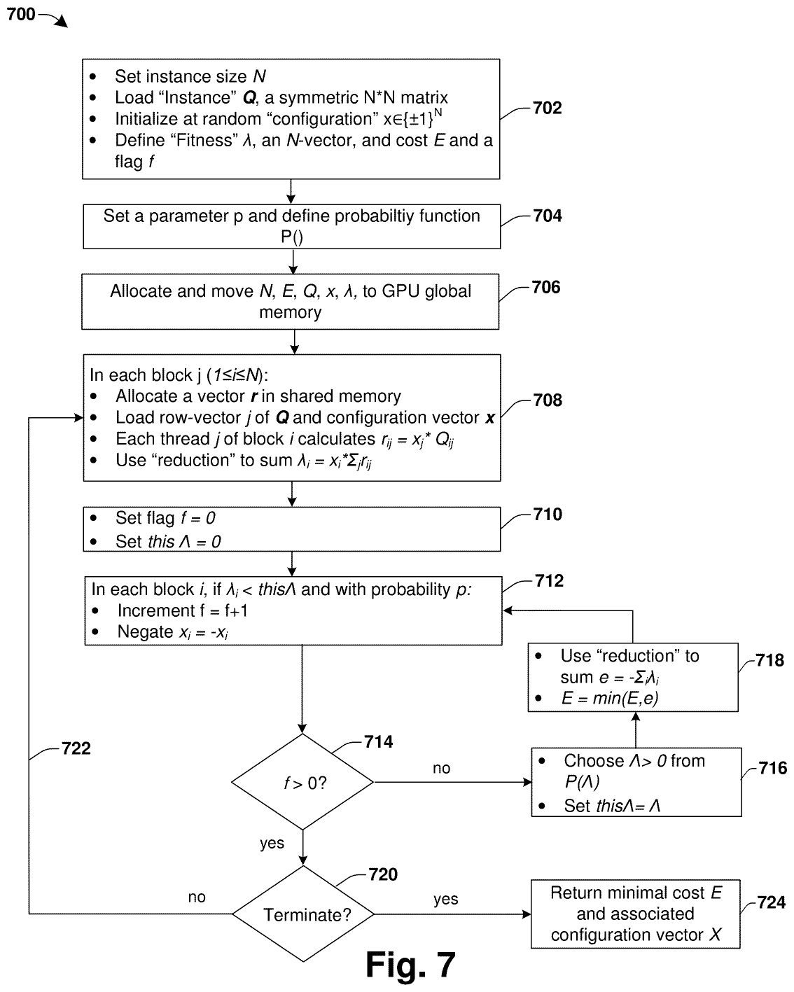

FIGS. 3A-4G show a plurality of exemplary iterations of the method 200 of FIG. 2. While FIGS. 3A-4G are described in relation to the method 200 of FIG. 2, it will be appreciated that the FIGS. 3A-4G are not limited to the method of FIG. 2 but rather may apply to other embodiments of the disclosed method (e.g., methods shown in FIG. 1 and/or FIG. 7). Furthermore, although the instance matrix and configuration vector are shown as having a specific size (e.g., N=5), it will be appreciated that the instance matrix and configuration vector are not limited to such a size but that such a size is illustrated to simplify a description of the disclosed method. Rather, one of ordinary skill in the art will appreciate that the disclosed instance matrix and/or configuration vector may respectively comprise thousands or millions of values.

FIGS. 3A-3H illustrate exemplary operations corresponding to a first iteration of a method of determining an optimized configuration vector for a combinatorial optimization problem.

As shown in FIG. 3A (e.g., corresponding to act 202 of FIG. 2), an instance matrix Qᵢⱼ comprises a plurality of instance values qᵢⱼ disposed in N rows and N columns (where N=5). In some embodiments, the instance matrix Qᵢⱼ may comprise a symmetric matrix. In such embodiments, values of the instance matrix Qᵢⱼ are symmetric about a diagonal 301 (e.g., instance value q₂₁ is equal to instance value q₁₂, instance value q₃₁ is equal to instance value q₁₃, etc.). In some embodiments, the values of the instance matrix Qᵢⱼ may be selected to correspond to an optimization task. For example, the instance matrix Qᵢⱼ may have values that correspond to a financial portfolio that is to be optimized using the disclosed method.

As shown in FIG. 3B (e.g., corresponding to act 204 of FIG. 2), a configuration vector Xⱼ is illustrated. The configuration vector Xⱼ includes a plurality of configuration values xⱼ disposed in an N×1 matrix (e.g., a matrix with N rows and 1 column), where N=5. In some embodiments, the plurality of configuration values xⱼ may comprise N Boolean variables or N variables with positive or negative values (e.g., values of ‘−1’ or ‘1’).

As shown in FIG. 3C (e.g., corresponding to act 208 of FIG. 2), a plurality of reduction values rᵢⱼ are determined. The plurality of reduction values rᵢⱼ are respectively determined by multiplying one of the plurality of instance values qi within the instance matrix Qᵢⱼ and one of the plurality of configuration values xⱼ within the configuration vector Xⱼ.

As shown in FIG. 3D (e.g., corresponding to act 210 of FIG. 2), a plurality of fitness values λᵢ are determined by multiplying a sum of the plurality of reduction values rᵢⱼ associated with respective rows of the instance matrix Qᵢⱼ by its respective configuration value xᵢ. For example, a first fitness values λ₁ may be determined by multiplying a sum of the plurality of reduction values r₁ⱼ associated with a first row of the instance matrix, Q₁ⱼ, by a first configuration value x₁; a second fitness values λ₂ may be determined by multiplying a sum the plurality of reduction values r₂ⱼ associated with a second row of the instance matrix, Q₂ⱼ by a second configuration value x₂; etc.

As shown in FIG. 3E (e.g., corresponding to act 212 of FIG. 2), a current cost E is determined to be equal to a negative of a sum of the plurality of fitness values λᵢ.

As shown in FIG. 3F (e.g., corresponding to act 214 of FIG. 2), a cost E is determined by taking a smaller of the cost and the current cost. In other words, if the current cost E_{current} is smaller than an existing cost E, the existing cost E will be replaced by the current cost E_{current} and recorded, and a configuration vector Xⱼ that was used to achieve the current cost E_{current} is also recorded. If the recorded cost E or counter meets the termination condition, the process can terminate and the recorded cost E and configuration are outputted (e.g., corresponding to acts 218-219 of FIG. 2).

As shown in FIG. 3G (e.g., corresponding to act 220 of FIG. 2), a flag f (i.e., a number of unstable values) is set to 0 and a value of a threshold Λ is set to 0. In some alternative embodiments (e.g., when xᵢ=0,1), the threshold Λ may be set to specific values other than zero.

As shown in FIG. 3H (e.g., corresponding to act 222 of FIG. 2), the plurality of fitness values λᵢ are compared to the threshold Λ. In this example, three unstable fitness values 303a-303c (counted by flag f (with f=3)), which are less than the threshold Λ, are identified.

As further shown in FIG. 3H (e.g., corresponding to the “yes” branch of act 224, leading to acts 226 and 228 of FIG. 2), for each of the unstable fitness values 303 identified, a probabilistic selection is made to determine if an associated configuration value xⱼ is negated. For unstable fitness values, 303a and 303c, that are selected by the probabilistic selection, an associated configuration value xⱼ is negated (e.g., act 228). For unstable fitness values 303b that are not selected by the probabilistic selection, an associated configuration value xⱼ is not negated.

For example, as shown in FIG. 3G, the three fitness values λ₁, λ₄, and λ₅ are less than the threshold Λ and therefore are identified as unstable fitness values. Furthermore, unstable fitness values λ₁ and λ₅ are associated with a random number pᵣ that is less than a predetermined probability value Pₜₕ and therefore associated configuration values x₁ and x₅ are negated. Alternatively, unstable fitness value λ₄ is associated with a random number pᵣ that is greater than the probability value Pₜₕ and therefore associated configuration value x₄ is not negated. In a resulting second configuration vector Xⱼ′, shown as 406, configuration values x₁ and x₅ have been negated.

Once the configuration vector Xⱼ has been adjusted to generate the second configuration vector Xⱼ′, an iteration of the method is complete and the method can move on to another iteration (e.g., corresponding to acts 206-230 of FIG. 2), shown in FIG. 4A-4G. In some embodiments, the method may move through a number of iterations that is proportional to N². In some such embodiments, each of the iterations may be counted by incrementing the counter value. Once the incremented counter exceeds a predetermined maximum value for the counter (can also be referred to as “counter threshold”), the method will end (e.g., corresponding to “no” branch of act 219 of FIG. 2).

As shown in FIG. 4A (e.g., corresponding to act 208 of FIG. 2), a second plurality of reduction values rᵢⱼ are respectively determined by multiplying one of the plurality of instance values qᵢⱼ within the instance matrix Qᵢⱼ and one of the plurality of configuration values xⱼ within the second configuration vector Xⱼ′.

As shown in FIG. 4B (e.g., corresponding to act 210 of FIG. 2), a second plurality of fitness values λᵢ are determined by summing the second plurality of reduction values rᵢⱼ associated with respective rows of the instance matrix Qᵢⱼ, and multiplying that sum with the respective configuration value xᵢ. For example, a first fitness value λ₁ may be determined by multiplying a sum of the plurality of reduction values r₁ⱼ associated with a first row of the instance matrix Q₁ⱼ by a first configuration value x₁; a second fitness value λ₂ may be determined by multiplying a sum of the plurality of reduction values r₂ⱼ associated with a second row of the instance matrix Q₂ⱼ by a second configuration value x₂; etc.

As shown in FIG. 4C (e.g., corresponding to act 212 of FIG. 2), a current cost E is determined by summing the plurality of fitness values λᵢ.

As shown in FIG. 4D (e.g., corresponding to act 214 of FIG. 2), a cost E is determined by taking a smaller of the cost E and the current cost E_{current}. A termination condition (e.g., corresponding to act 219 of FIG. 2) is then evaluated. In this example, the termination condition (e.g., counter value or cost value) has not been satisfied so the method continues to act 220 of FIG. 2.

As shown in FIG. 4E (e.g., corresponding to act 220 of FIG. 2), a flag f is set to 0 and a value of a threshold Λ is set to 0. In some alternative embodiments (e.g., when xᵢ=0,1), the threshold Λ may be set to a specific value other than zero.

As shown in FIG. 4F (e.g., corresponding to act 222 of FIG. 2), the plurality of fitness values λᵢ are compared to the threshold Λ to identify unstable fitness values, and the flag f is determined by counting the number of unstable fitness values. Since none of the plurality of fitness values λᵢ are less than the threshold Λ, no unstable fitness values are identified. Therefore, (e.g., corresponding to no branch at act 224 to act 232 of FIG. 2), the threshold Λ is adjusted to generate an updated threshold Λ′. The threshold Λ may be adjusted according to a probability function Pτ(Λ) to generate the updated threshold Λ′ (e.g., corresponding to act 232 of FIG. 2). In some embodiments, the probability function Pτ(Λ) is configured to generate a threshold adjustment value ΔΛ that is added to the threshold Λ to determine the updated threshold Λ′.

After the threshold Λ is adjusted to generate the updated threshold Λ′, the plurality of fitness values λᵢ are compared to the updated threshold Λ′, as shown in FIG. 4G (e.g., corresponding to act 222 of FIG. 2). As further shown in FIG. 4G (e.g., corresponding to act 224 of FIG. 2), in this example, fitness values of the plurality of fitness values λᵢ that are less than the updated threshold Λ′ are identified as unstable fitness values 403a-403c, resulting in f=3. For each of the unstable fitness values 403a-403c identified, a probabilistic selection is made to determine if an associated configuration value is negated. For unstable fitness values, 403a and 403b, that are selected by the probabilistic selection, an associated configuration value xⱼ is negated. For unstable fitness values 403c that are not selected by the probabilistic selection, as well as stable fitness values, an associated configuration value xⱼ is not negated.

For example, as shown in FIG. 4G, unstable fitness values λ₁, λ₃, and λ₄ are identified. Furthermore, unstable fitness values λ₁ and λ₃ are associated with a random number pᵣ that is less than a preset probability value Pₜₕ and therefore associated configuration value x₁ and x₃ are negated. Alternatively, unstable fitness value λ₄ is associated with a random number pᵣ that is greater than a probability value Pₜₕ and therefore associated configuration value x₄ is not negated. The resulting third configuration vector Xⱼ″ is shown in FIG. 4G. Since the prior configuration vector is (−x₁, x₂, x₃, x₄, −x₅), the updated configuration vector is now equal to (x₁, x₂, −x₃, x₄, −x₅) relative to their initial configuration values at the start of the first iteration.

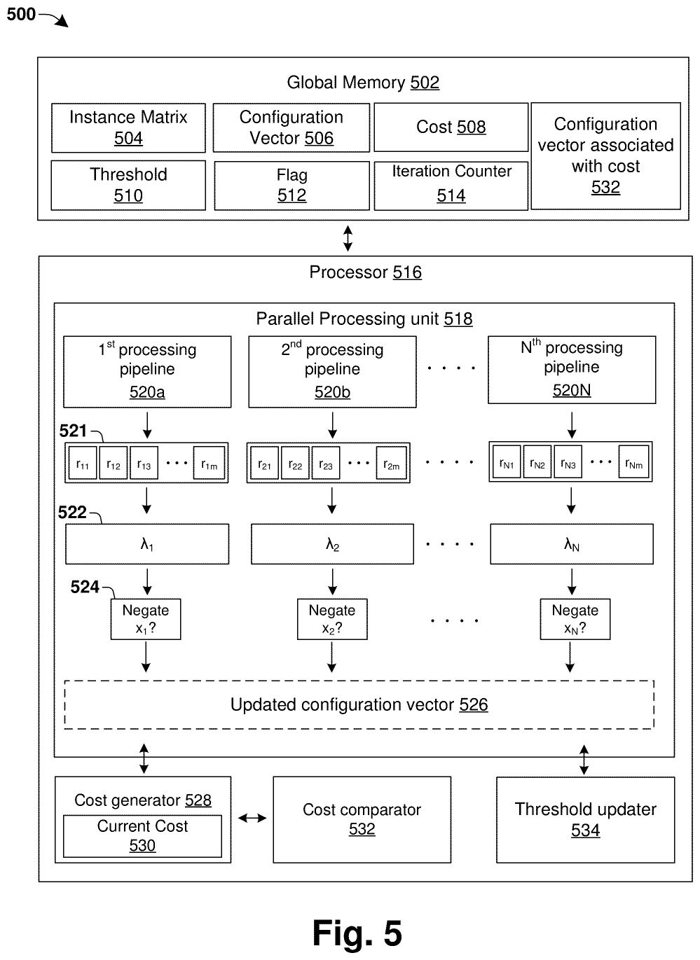

FIG. 5 illustrate a block diagram of an apparatus 500 configured to determine an optimized configuration vector for a combinatorial optimization problem.

The apparatus 500 comprises a global memory 502 and a processor 516. In some embodiments, the global memory 502 may comprise electronic memory (e.g., solid state memory, SRAM (static random-access memory), DRAM (dynamic random-access memory), and/or the like). The processor 516 can, in various embodiments, comprise circuitry such as, but not limited to, one or more single-core or multi-core processors. The processor 516 can include any combination of general-purpose processors and dedicated processors (e.g., graphics processors, application processors, etc.). In some embodiments, the processor 516 may comprise a GPU (graphics processing unit). In other embodiments, the processor 516 may comprise a quantum computer having a network structure comprising qubits (e.g., a quantum annealing computer).

The global memory 502 is configured to store an instance matrix 504 and a configuration vector 506. In some embodiments, the instance matrix 504 and/or the configuration vector 506 may be received from a user, the internet, an online database, and/or the like. The global memory 502 may further be configured to store a cost 508, a threshold 510, a flag f 512, and an iteration counter 514.

In some embodiments, the processor 516 may comprise a parallel processing unit 518. The parallel processing unit 518 comprises a plurality of processing pipelines 520a-520N that are configured to operate in parallel. The plurality of processing pipelines 520a-520N are respectively configured to multiply instance values within a row of the instance matrix 504 and configuration values within the configuration vector 506 to simultaneously generate a plurality of reduction values 521. In some embodiments, the plurality of processing pipelines 520a-520N operate to simultaneously execute a single multiplication operation that generates a reduction value by multiplying an instance value from a row of the instance matrix 504 with a configuration value of the configuration vector 506 (e.g., rᵢⱼ=xⱼ*Qᵢⱼ). Therefore, the plurality of processing pipelines 520a-520N simultaneously determine a plurality of reduction values 521 associated with rows of the instance matrix 504.

The parallel processing unit 518 may respectively sum the plurality of reduction values 521 and multiply that sum with the respective configuration value (e.g., associated with a row of the instance matrix 504) to simultaneously determine a plurality of fitness values 522. In some embodiments, the parallel processing unit 518 may sum the plurality of reduction values 521 using reduction. In some embodiments, the reduction sums N (e.g., a power of 2) terms recursively within a block of a GPU, where the last N/2 terms are added one-by-one to the first N/2, then the second N/4 term to the first N/4, then the second N/8 to the first N/8, etc., until all terms have added into the first entry. In this way, the sequential addition of N terms has been parallelized into log₂(N) sequential steps.

The parallel processing unit 518 may be further configured to simultaneously assess the plurality of fitness values 522 to determine if there are any unstable fitness values (e.g., fitness values that are negative). In some embodiments, the parallel processing unit 518 may be configured to operate in parallel to compare the plurality of fitness values 522 to the threshold 510 to identify unstable fitness values. If any of the plurality of fitness values 522 are smaller than the threshold 510, then the parallel processing unit 518 is further configured to make a probabilistic decision of whether or not to negate an associated configuration value. In some embodiments, the parallel processing unit 518 may make the probabilistic decision by comparing a random number to a predetermined probability value. If the random number is below the predetermined probability value, then a configuration value associated with an unstable fitness value is negated to generate an updated configuration vector 526. The updated configuration vector 526 is provided back to the global memory 502, which overwrites the configuration vector 506 with the updated configuration vector 526.

The processor 516 may further comprise a cost generator 528 configured to generate a current cost 530 from the plurality of fitness values 522. In some embodiments, the cost generator 528 may be configured to generate the current cost 530 by summing the plurality of fitness values 522. A cost comparator 532 is configured to compare the current cost 530 to the cost 508 stored in the global memory 502. If the current cost 530 is lower than the cost 508, the cost comparator 532 is configured to overwrite a value of the cost 508 with the current cost 530 and to save the configuration vector used to generate the current cost 530 within the global memory 502. If the current cost 530 is not lower than the cost 508, then the cost comparator 532 will not overwrite the value of the cost 508.

The processor 516 may further comprise a threshold updater 534. If none of the plurality of fitness values 522 are smaller than the threshold 510, then the threshold updater 534 is configured to update a value of the threshold 510. In some embodiments, the threshold updater 534 may update the value of the threshold 510 according to a probabilistic function. Once the value of the threshold 510 has been updated, the parallel processing unit 518 may once again operate in parallel to compare the plurality of fitness values 522 to the threshold 510 to identify unstable fitness values.

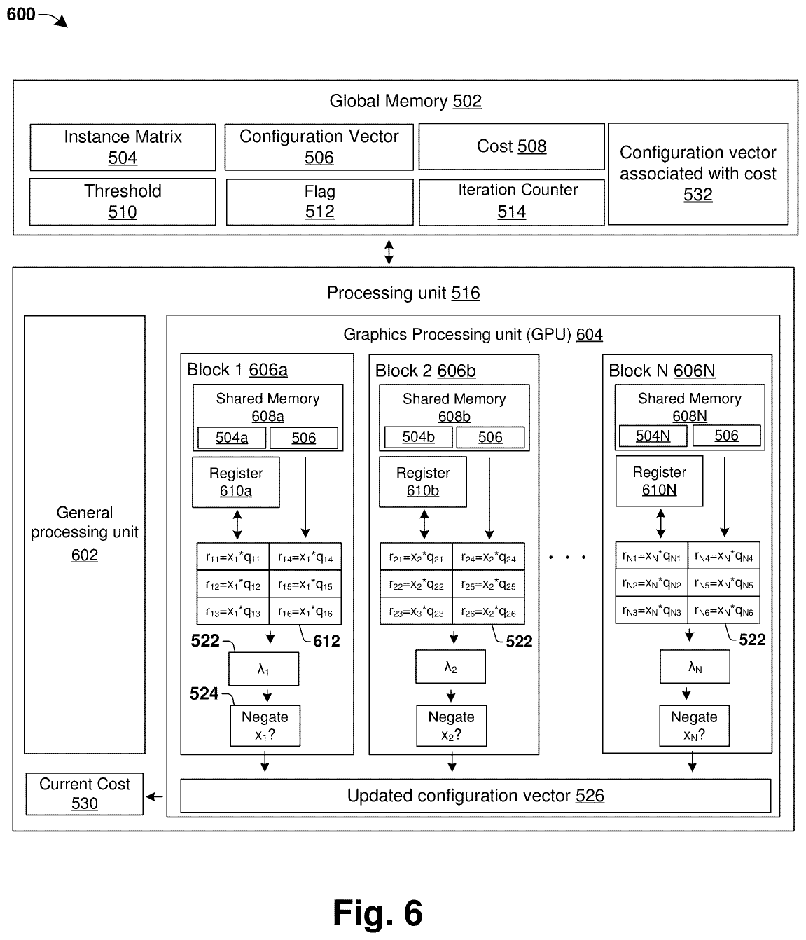

FIG. 6 illustrate a block diagram of an apparatus 600 configured to determine an optimized configuration vector for a combinatorial optimization problem.

The apparatus 600 comprises a global memory 502 and a processor 516. The global memory 502 is configured to store an instance matrix 504 and a configuration vector 506. The global memory 502 may be further configured to store a cost 508, a threshold 510, a flag 512, and an iteration counter 514.

In some embodiments, the processor 516 may comprise a general processing unit 602 and a graphics processing unit (GPU) 604. The GPU 604 may comprise a plurality of blocks 606a-606N respectively comprising a plurality of threads 622. In some embodiments, the plurality of blocks 606a-606N respectively include 1,024 threads. In some embodiments, the GPU 604 may further comprise a plurality of shared memory elements 608a-608N configured to store instructions to perform operations and/or methods discussed herein.

The plurality of blocks 606a-606N are in communication with the plurality of shared memory elements 608a-608N. During operation, data may be moved between the global memory 502 and the plurality of shared memory elements 608a-608N. For example, one or more of the instance matrix 504, the configuration vector 506, the cost 508, the threshold 510, the flag 512, and the iteration counter 514 may be moved from the global memory 502 to the plurality of shared memory elements 608a-608N. In some embodiments, the plurality of shared memory elements 608a-608N may be configured to store at least one row 504a-504N of the instance matrix 504 and the configuration vector 506. In some embodiments, the general processing unit 602 is configured to operate a kernel that provides a row of the instance matrix 504a-504N and the configuration vector 506 to one of the plurality of shared memory elements 608a-608N.

Respective ones of the plurality of blocks 606a-606N are further configured to operate upon the row of the instance matrix 504a-504N and the configuration vector 506 to generate a plurality of reduction values. In some embodiments, the plurality of blocks 606a-606N may respectively comprise a plurality of threads 522. The plurality of threads 522 of the plurality of blocks 606a-606N may be operated to simultaneously execute a single multiplication operation that generate a reduction value by multiplying an instance value from a row of the instance matrix 504a-504N with a configuration value of the configuration vector 506 (e.g., rᵢⱼ=xᵢ*Qⱼᵢ). Therefore, the plurality of threads 522 of one of the plurality of blocks 606a-606N determines a plurality of reduction values associated with a row of the instance matrix 504. In some embodiments, the plurality of reduction values may be stored in the shared memory elements 608a-608N. In other embodiments, the plurality of reduction values may be stored in a plurality of registers 610a-610N respectively associated with the plurality of blocks 606a-606N.

In some embodiments, there may be a number of the plurality of threads 522 (e.g., 1024 threads) within each of the plurality of blocks 606a-606N. If the configuration vector 506 has a number of configuration values that is larger than the number of the plurality of threads (e.g., the configuration vector has N>1024 elements), each of the plurality of reduction value may hold multiple terms (e.g., rᵢⱼ=xᵢ*Qⱼᵢ+xᵢ₊₁₀₂₄*Qⱼᵢ₊₁₀₂₄+xᵢ₊₂₀₄₈*Qⱼᵢ₊₂₀₄₈+ . . . ). If the configuration vector 506 has a number of configuration values that is less than or equal to the number of the plurality of threads (e.g., the configuration vector has N≥1024 elements), the plurality of reduction values will be a number of reduction values that is equal to a number of configuration values within the configuration vector 506.

In some embodiments, the plurality of blocks 606a-606N may respectively sum the plurality of reduction values generated by a block (e.g., associated with a row of the instance matrix 504a-504N) and multiply that sum with the respective configuration value to determine a plurality of fitness values 522. In some embodiments, the plurality of blocks 606a-606N may sum the plurality of reduction values using reduction. By using the plurality of blocks 606a-606N to simultaneously determine the plurality of reduction values and the plurality of fitness values 522, an amount of time that is used to determine the plurality of fitness values 522 can be greatly decreased, thereby increasing an efficiency of the disclosed apparatus 600 (e.g., making the disclosed apparatus 600 faster and thus more valuable for large datasets that may be found in commercial applications) and allowing for the disclosed apparatus 600 to provide a technical benefit over conventional systems.

The plurality of blocks 606a-606N may be further operated to simultaneously assess the plurality of fitness values 522 (e.g., in parallel) to determine if there are any unstable fitness values (e.g., fitness values that are negative). In some embodiments, the plurality of blocks 606a-606N may be configured to operate in parallel to compare the plurality of fitness values 522 to the threshold 510 to identify unstable fitness values.

If any of the plurality of fitness values 522 are unstable fitness values, then an associated one of the plurality of blocks 606a-606N is further configured to make a probabilistic decision of whether or not to negate the associated configuration value. In some embodiments, the plurality of blocks 606a-606N may make the probabilistic decision by comparing a random number to a predetermined probability value. If the random number is below the predetermined probability value, then a block will negate a configuration value associated with an unstable fitness value to generate an updated configuration vector 526. The updated configuration vector 526 is provided back to the global memory 502, which overwrites the configuration vector 506 with the updated configuration vector 526.

If none of the plurality of fitness values 522 are unstable fitness values, then the processor 516 is configured to update a value of the threshold 510. In some embodiments, the processor 516 may update the value of the threshold 510 according to a probabilistic function. Once the value of the threshold 510 has been updated, the GPU 604 once again operates in parallel to compare the plurality of fitness values 522 to the threshold 510 to identify unstable fitness values.

The processor 516 may be further configured to generate a current cost 530 from the plurality of fitness values 522. In some embodiments, the processor 516 may be further configured to generate the current cost 530 by summing the plurality of fitness values 522. If the current cost 530 is lower than the cost 508, the processor 516 is configured to overwrite a value of the cost 508 with the current cost 530 and to save the configuration vector used to generate the cost 530 within the global memory 502. If the current cost 530 is not lower than the cost 508, then the processor 516 will not overwrite the value of the cost 508.

FIG. 7 illustrates some additional embodiments of a flow diagram of a method 700 of determining an optimized configuration vector.

At act 702, initial parameters and variables are defined. In some embodiments, the initial parameters and variables may include an instance matrix, a configuration vector, a fitness (which is an N-vector), a cost and a flag f. The instance matrix may be formed to be an N×N symmetric matrix that has values associated with an optimization task. The configuration vector may be formed to be an N×1 matrix having configuration values that are random Boolean values, that are values of −1 and +1, or the like. The fitness, the cost, and the flag f may be formed to have a value of zero.

At act 704, a parameter p and a probability function P( ) are defined.

At act 706, the N-vector of fitnesses, the cost, the instance matrix, and the configuration vector are saved in a global memory of a processor (e.g., a GPU).

At act 708, a kernel is operated by the processor to move the cost, the instance matrix, the configuration vector and the fitness to shared memory elements within the processor. A plurality of blocks within the processor, which respectively comprise a plurality of threads, are operated upon the parameters stored in the shared memory elements. The plurality of blocks are respectively configured to allocate a vector r in a shared memory element, to load a row-vector j of the instance matrix and configuration vector in the shared memory elements. Then each thread of a block is configured to calculate a reduction value (e.g., a thread j of block i is configured to calculate reduction value rᵢⱼ=xⱼ*Qᵢⱼ). The multiplication is executed N² times for the entire instance matrix Q. The multiplication may be done in parallel, so that all of the multiplication operations are done in a single timestep. The plurality of blocks may then use “reduction” to sum the reduction values and determine a fitness value, λᵢ=xᵢ*Σᵢrᵢⱼ.

At act 710, values of the flag f and the threshold are set equal to zero.

At act 712, for each of the fitness values in parallel, it is decided whether or not to negate an associated configuration value (e.g., either xᵢ becomes −xᵢ or xᵢ becomes 1−xᵢ, i.e. NOT of xᵢ). The decision to negate an associated configuration value is made if an associated fitness value λᵢ is less than the threshold value Λ (e.g., λ[i]<Λ) and if a random number is smaller than a predetermined probability value Pₜₕ. If both criteria are satisfied, the flag f is incremented and at least one configuration value is negated.

At act 714, if the flag f does not have a value that is greater than zero (e.g., if no configuration values were negated) and if a counter has not yet passed a termination value (e.g., proportional to N²), the threshold value Λ is updated at act 716. In some embodiments, the threshold value is increased by a threshold adjustment value ΔΛ that is determined using a probabilistic function P( ). The probabilistic function selects the threshold adjustment value ΔΛ at random from a specific distribution.

At act 718, a current cost e may be determined by summing the plurality of fitness values λᵢ. A cost E may then be determined by comparing the current cost e to the cost E. The smaller of the current cost e and the cost E is determined to be the cost E. The method 700 then returns to act 712.

At act 714, if the flag f has a value that is greater than 0, a counter will be compared to a predetermined maximum value for the counter (can also be referred to as “counter threshold”) (at act 720) to determine if a sufficient number of iterations have been performed. If the counter does not meet the predetermined maximum value for the counter, the method will proceed to act 708 (via act 722). If the counter does meet the predetermined maximum value for the counter, the method will proceed to act 724, and the method will return a minimal cost value E along with an associated configuration vector X that was used to achieve the minimal cost value E.

The use of a threshold Λ to be able to simultaneously assess the plurality of fitness values and selectively update associated configuration values, along with the conditional choice of ΔΛ, allows the disclosed method 700 to operate in parallel and obtain a complexity of ˜log (N) in each iteration. Since it has been appreciated that ˜N² iterations suffice to produce results of consistent precision, the overall parallel disclosed algorithm uses ˜log (N)*N² timesteps. This is significantly improved over algorithms that are inherently sequential (e.g., that use ˜N⁴ timesteps to obtain results of comparable precision).

Therefore, the present disclosure relates to a method and apparatus configured to efficiently solve a combinatorial optimization problem (e.g., a QUBO problem).

It will be appreciated that the disclosed methods and/or block diagrams may be implemented as computer-executable instructions, in some embodiments. Thus, in one example, a computer-readable storage device (e.g., a non-transitory computer-readable medium) may store computer executable instructions that if executed by a machine (e.g., computer, processor) cause the machine to perform the disclosed methods and/or block diagrams. While executable instructions associated with the disclosed methods and/or block diagrams are described as being stored on a computer-readable storage device, it is to be appreciated that executable instructions associated with other example disclosed methods and/or block diagrams described or claimed herein may also be stored on a computer-readable storage device.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage device”, as used herein, refers to a device that stores instructions or data. “Computer-readable storage device” does not refer to propagated signals. A computer-readable storage device may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage device may include, but are not limited to, a floppy disk, a flexible disk, a hard disk, a magnetic tape, other magnetic medium, an application specific integrated circuit (ASIC), a compact disk (CD), other optical medium, a random access memory (RAM), a read only memory (ROM), a memory chip or card, a memory stick, and other media from which a computer, a processor or other electronic device can read.

“Circuit”, as used herein, includes but is not limited to hardware, firmware, software in execution on a machine, or combinations of each to perform a function(s) or an action(s), or to cause a function or action from another logic, method, or system. A circuit may include a software controlled microprocessor, a discrete logic (e.g., ASIC), an analog circuit, a digital circuit, a programmed logic device, a memory device containing instructions, and other physical devices. A circuit may include one or more gates, combinations of gates, or other circuit components. Where multiple logical circuits are described, it may be possible to incorporate the multiple logical circuits into one physical circuit. Similarly, where a single logical circuit is described, it may be possible to distribute that single logical circuit between multiple physical circuits.

To the extent that the term “includes” or “including” is employed in the detailed description or the claims, it is intended to be inclusive in a manner similar to the term “comprising” as that term is interpreted when employed as a transitional word in a claim.

Throughout this specification and the claims that follow, unless the context requires otherwise, the words ‘comprise’ and ‘include’ and variations such as ‘comprising’ and ‘including’ will be understood to be terms of inclusion and not exclusion. For example, when such terms are used to refer to a stated integer or group of integers, such terms do not imply the exclusion of any other integer or group of integers.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and other embodiments have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and other embodiments described herein. Therefore, the invention is not limited to the specific details, the representative apparatus, and illustrative examples shown and described. Thus, this application is intended to embrace alterations, modifications, and variations that fall within the scope of the appended claims.

What is claimed is:

1. A method, comprising:
accessing an instance matrix comprising a plurality of instance values disposed in rows and columns;
accessing a configuration vector comprising a plurality of configuration values;
performing one or more iterations on a computing apparatus to determine an optimized configuration vector, the one or more iterations respectively comprising:
simultaneously determining a plurality of reduction values by multiplying the plurality of configuration values by instance values within a row of the instance matrix;
determining a plurality of fitness values respectively associated with one of the rows, wherein respective ones of the plurality of fitness values are determined by summing the plurality of reduction values associated with a row of the instance matrix and multiplying each sum by the respective configuration value;
determining a current cost by summing the plurality of fitness values;
simultaneously identifying unstable fitness values based upon a comparison of the plurality of fitness values with a threshold; and
simultaneously updating at least one of the plurality of configuration values associated with the unstable fitness values based upon a probabilistic selection.

2. The method of claim 1, wherein the one or more iterations further comprise:
incrementing a flag if at least one of the plurality of configuration values is updated;
generating a threshold adjustment value if the flag is not incremented, the threshold adjustment value being generated by a probability function; and
setting the threshold equal to a threshold value plus the threshold adjustment value.

3. The method of claim 1, further comprising:
replacing a cost with the current cost if the current cost is lower than the cost.

4. The method of claim 1, wherein the instance matrix is an N×N symmetric matrix and the configuration vector is an N×1 matrix.

5. The method of claim 4, wherein the computing apparatus is configured to perform a number of iterations that is proportional to N².

6. The method of claim 1, further comprising:
loading a row of the instance matrix and the configuration vector into a shared memory element of a block within a parallel processing unit; and
calculating respective ones of the plurality of reduction values in parallel using different threads within the block.

7. The method of claim 6, wherein the computing apparatus is a graphics processing unit (GPU).

8. The method of claim 6, wherein the computing apparatus is a quantum computer.

9. The method of claim 1, wherein updating the configuration values comprises negating the configuration values.

10. The method of claim 1, wherein the threshold is equal to zero prior to identifying the unstable fitness values.

11. The method of claim 1, further comprising:
identifying a first number of unstable fitness values; and
randomly updating a second number of configuration values associated with the unstable fitness values, wherein the first number is larger than the second number.

12. The method of claim 1, further comprising:
multiplying a first instance value within the row of the instance matrix with a first configuration value to determine a first reduction value; and
multiplying a second instance value within the row of the instance matrix with a second configuration value to determine a second reduction value.

13. A non-transitory computer-readable medium storing computer-executable instructions that, when executed, cause a processor to perform operations, comprising:
simultaneously determining a plurality of reduction values by multiplying a plurality of configuration values within a configuration vector by instance values within a row of an instance matrix;
determining a plurality of fitness values respectively associated with one of the rows, wherein respective fitness values of the plurality of fitness values are determined by summing the plurality of reduction values associated with a row of the instance matrix and multiplying each sum by the respective configuration value;
determining a current cost by summing the plurality of fitness values;
simultaneously identifying a first number of unstable fitness values based upon a comparison of the plurality of fitness values with a threshold value;
simultaneously negating a second number of configuration values associated with the unstable fitness values based upon a probabilistic selection, wherein the first number is larger than the second number; and
updating the threshold value using a probabilistic function if no unstable fitness values are identified.

14. The non-transitory computer-readable medium of claim 13, wherein the configuration vector is a N×1 matrix and the instance matrix is an N×N matrix.

15. The non-transitory computer-readable medium of claim 13, wherein the operations further comprise:
loading a row of the instance matrix and the configuration vector into a shared memory element of a block within the processor; and
calculating respective ones of the plurality of reduction values in parallel using different threads within the block.

16. An apparatus, comprising:
a global memory configured to store an instance matrix, a configuration vector, and a threshold; and
a processor configured to perform one or more iterations to determine an optimized configuration vector, the one or more iterations respectively comprising:
simultaneously determining a plurality of reduction values corresponding to each row of the instance matrix, wherein the plurality of reduction values are determined by multiplying configuration values within the configuration vector and instance values within a row of the instance matrix;
determining a plurality of fitness values respectively associated with one of the rows, wherein respective fitness values are determined by summing the reduction values associated with a row of the instance matrix and multiplying each sum by the respective configuration value;
determining a current cost by summing the plurality of fitness values;
simultaneously identifying one or more unstable fitness values based upon a comparison of the plurality of fitness values with a threshold; and
simultaneously updating at least one of the configuration values associated with the one or more unstable fitness values based upon a probabilistic selection.

17. The apparatus of claim 16, wherein the processor includes a parallel processing unit, the parallel processing unit comprising:
a plurality of shared memory elements, wherein the plurality of shared memory elements are respectively configured to store the configuration vector and one row of the instance matrix; and
a plurality of blocks in communication with the plurality of shared memory elements and respectively including a plurality of threads, wherein the plurality of threads are respectively configured to multiply one of the configuration values with one of the instance values within the row of the instance matrix.

18. The apparatus of claim 17, wherein the plurality of blocks respectively include 1,024 threads.

19. The apparatus of claim 17, wherein the one or more iterations further comprise:
generating a threshold adjustment value if at least one unstable fitness value is not identified;
setting the threshold equal to a threshold value plus the threshold adjustment value; and
simultaneously identifying one or more unstable fitness values based upon a comparison of the plurality of fitness values with the threshold.

20. The apparatus of claim 17, wherein the one or more iterations further comprise:
multiplying a first instance value within the row of the instance matrix with a first configuration value to determine a first reduction value; and
multiplying a second instance value within the row of the instance matrix with a second configuration value to determine a second reduction value.
